(19) United States
(12) Patent Application Publication
(10) Pub. No.: US 2021/0403376 A1
(43) Pub. Date: Dec. 30, 2021

(54) GLASS-CERAMIC ARTICLE WITH SURFACE PASSIVATION LAYER AND METHODS FOR PRODUCING THE SAME

(71) Applicant: Corning Incorporated, Corning, NY (US)

(72) Inventors: Haixing Chen, Shanghai (CN); Jiangwei Feng, Painted Post, NY (US); Meng Qin, Shanghai (CN); Ljerka Ukrainczyk, Ithaca, NY (US)

(21) Appl. No.: 17/359,772

(22) Filed: Jun. 28, 2021

Related U.S. Application Data
(60) Provisional application No. 63/073,653, filed on Sep. 2, 2020.
(60) Provisional application No. 63/046,492, filed on Jun. 30, 2020.

(51) Int. Cl. C03C 17/42; H05K 5/00; H05K 5/03

(52) U.S. Cl. CPC C03C 17/42; H05K 5/0017; C03C 2218/11; C03C 2217/213; C03C 2217/76; H05K 5/03

(57) ABSTRACT

A glass-ceramic article is provided that includes a surface passivation layer. The passivation layer is an oxide layer and has a thickness of greater than or equal to 20 nm to less than or equal to 200 nm and a RMS surface roughness of less than or equal to 3 nm. The surface passivation layer may be formed with a liquid phase deposition process. The glass-ceramic article may include an easy to clean layer disposed on the surface passivation layer, and the glass-ceramic article may be chemically strengthened. The glass-ceramic article may be used in a consumer electronic product.

This application claims the benefit of priority of U.S. Provisional Application Ser. No. 63/073,653 filed on Sep. 2, 2020 and U.S. Provisional Application Ser. No. 63/046,492 filed on Jun. 30, 2020, the content of each are relied upon and incorporated herein by reference in their entirety.

### BACKGROUND

### Field

The present specification generally relates to glass-ceramic articles suitable for use as cover glass for electronic devices.

### Technical Background

The mobile nature of portable devices, such as smart phones, tablets, portable media players, personal computers, and cameras, makes these devices particularly vulnerable to accidental dropping on hard surfaces, such as the ground. These devices typically incorporate cover glasses, which may become damaged upon impact with hard surfaces. In many of these devices, the cover glasses function as display covers, and may incorporate touch functionality, such that use of the devices is negatively impacted when the cover glasses are damaged.

There are two major failure modes of cover glass when the associated portable device is dropped on a hard surface. One of the modes is flexure failure, which is caused by bending of the glass when the device is subjected to dynamic load from impact with the hard surface. The other mode is sharp contact failure, which is caused by introduction of damage to the glass surface. Impact of the glass with rough hard surfaces, such as asphalt, granite, etc., can result in sharp indentations in the glass surface. These indentations become failure sites in the glass surface from which cracks may develop and propagate.

Glass can be made more resistant to flexure failure by the ion-exchange technique, which involves inducing compressive stress in the glass surface. However, the ion-exchanged glass will still be vulnerable to dynamic sharp contact, owing to the high stress concentration caused by local indentations in the glass from the sharp contact.

It has been a continuous effort for glass makers and handheld device manufacturers to improve the resistance of handheld devices to sharp contact failure. Solutions range from coatings on the cover glass to bezels that prevent the cover glass from impacting the hard surface directly when the device drops on the hard surface. However, due to the constraints of aesthetic and functional requirements, it is very difficult to completely prevent the cover glass from impacting the hard surface.

To produce increased performance, glass-ceramic materials have been investigated for use in electronic devices. Glass-ceramic materials may provide higher strengths than glass materials, but also present challenges that are not encountered when utilizing glass materials as cover glasses in electronic devices. For example, the presence of different crystalline and amorphous phases at the surfaces of glass-ceramic materials may present challenges when attempting to achieve a uniform surface or depositing coatings thereon.

Accordingly, a need exists for materials, such as glass-ceramic materials that can be strengthened, such as by ion exchange, and that are suitable for use as display covers and/or housings in electronic devices.

### SUMMARY

According to aspect (1), an article is provided. The article includes: a glass-ceramic substrate comprising a surface; an oxide layer disposed over the surface of the glass-ceramic substrate; wherein the oxide layer has a thickness of greater than or equal to 20 nm to less than or equal to 200 nm and a RMS surface roughness of less than or equal to 3 nm.

According to aspect (2), the article of aspect (1) is provided, further comprising an easy-to-clean layer disposed over the oxide layer.

According to aspect (3), the article of aspect (2) is provided, wherein the easy-to-clean layer comprises perfluoropolyether.

According to aspect (4), the article of any of aspects (1) to (3) is provided, wherein the article exhibits a transmittance haze of less than or equal to 0.15%.

According to aspect (5), the article of any of aspects (1) to (4) is provided, wherein the article exhibits a transmittance of greater than or equal to 90% over the entirety of the wavelength range from 400 nm to 700 nm.

According to aspect (6), the article of any of aspects (1) to (5) is provided, wherein the glass-ceramic substrate comprises: petalite, lithium disilicate, lithium silicate, lithium phosphate, beta-spodumene, beta-quartz, spinel, mullite, fluormica, lithium metasilicate, forsterite, nepheline, Li—Zn—Mg orthosilicate, or combinations thereof.

According to aspect (7), the article of any of aspects (1) to (6) is provided, wherein the glass-ceramic substrate comprises petalite and lithium disilicate.

According to aspect (8), the article of any of aspects (1) to (7) is provided, wherein the oxide layer comprises SiO₂, Al₂O₃, TiO₂, or combinations thereof.

According to aspect (9), the article of any of aspects (1) to (8) is provided, wherein the oxide layer comprises SiO₂.

According to aspect (10), the article of any of aspects (1) to (9) is provided, wherein the glass-based substrate further comprises a compressive stress layer extending from the surface to a depth of compression.

According to aspect (11), a consumer electronic product is provided. The consumer electronic product including: a housing comprising a front surface, a back surface and side surfaces; electrical components at least partially within the housing, the electrical components comprising a controller, a memory, and a display, the display at or adjacent the front surface of the housing; and a cover plate disposed over the display, wherein at least a portion of at least one of the housing or the cover plate comprises the article of any of aspects (1) to (10).

According to aspect (12), a method is provided. The method includes: contacting a liquid solution with a surface of a glass-ceramic substrate to deposit an oxide layer on the surface forming a glass-ceramic article; wherein the oxide has a thickness of greater than or equal to 20 nm to less than or equal to 200 nm and a RMS surface roughness of less than or equal to 3 nm.

According to aspect (13), the method of aspect (12) is provided, wherein during the contacting the liquid solution is at a temperature of greater than or equal to 25° C. to less than or equal to 60° C.

According to aspect (14), the method of aspect (12) or (13) is provided, wherein the contacting extends for a time period of greater than or equal to 2 minutes to less than or equal to 1 hour.

According to aspect (15), the method of any of aspects (12) to (14) is provided, wherein the liquid solution comprises H₂SiF₆ and at least one of B(OH)₃ or Ca(OH)₂.

According to aspect (16), the method of any of aspects (12) to (15) is provided, wherein the liquid solution comprises H₂SiF₆ with a concentration of greater than or equal to 0.1 M to less than or equal to 3 M.

According to aspect (17), the method of any of aspects (12) to (16) is provided, wherein the liquid solution comprises B(OH)₃ with a concentration of greater than or equal to 0.05 M to less than or equal to 2.0 M.

According to aspect (18), the method of any of aspects (12) to (17) is provided, wherein the liquid solution comprises Ca(OH)₂ with a concentration of greater than or equal to 0.01 M to less than or equal to 2.0 M.

According to aspect (19), the method of any of aspects (12) to (18) is provided, wherein the liquid solution comprises Al₂(SO₄)₆ and NaHCO₃.

According to aspect (20), the method of any of aspects (12) to (19) is provided, wherein the liquid solution comprises (NH₄)₂TiF₆ and B(OH)₃.

According to aspect (21), the method of any of aspects (12) to (20) is provided, further comprising disposing an easy-to-clean layer over the oxide layer.

According to aspect (22), the method of any of aspects (12) to (21) is provided, wherein the easy-to-clean layer comprises perfluoropolyether.

According to aspect (23), the method of any of aspects (12) to (22) is provided, wherein the glass-ceramic article exhibits a transmittance haze of less than or equal to 0.15%.

According to aspect (24), the method of any of aspects (12) to (23) is provided, wherein the glass-ceramic article exhibits a transmittance of greater than or equal to 90% over the entirety of the wavelength range from 400 nm to 700 nm.

According to aspect (25), the method of any of aspects (12) to (24) is provided, wherein the glass-ceramic substrate comprises: petalite, lithium disilicate, lithium silicate, lithium phosphate, beta-spodumene, beta-quartz, spinel, mullite, fluormica, lithium metasilicate, forsterite, nepheline, Li—Zn—Mg orthosilicate, or combinations thereof.

According to aspect (26), the method of any of aspects (12) to (25) is provided, wherein the glass-ceramic substrate comprises petalite and lithium disilicate.

According to aspect (27), the method of any of aspects (12) to (26) is provided, wherein the oxide layer comprises SiO₂, Al₂O₃, TiO₂, or combinations thereof.

According to aspect (28), the method of any of aspects (12) to (27) is provided, wherein the oxide layer comprises SiO₂.

According to aspect (29), the method of any of aspects (12) to (28) is provided, wherein the glass-based substrate further comprises a compressive stress layer extending from the surface to a depth of compression.

Additional features and advantages will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts a cross section of a glass having compressive stress layers on surfaces thereof according to embodiments disclosed and described herein;

FIG. 2A is a plan view of an exemplary electronic device incorporating any of the glass articles disclosed herein;

FIG. 2B is a perspective view of the exemplary electronic device of FIG. 2A;

FIG. 3 is atomic force microscopy (AFM) images of a glass-ceramic substrate at two different magnifications after polishing and washing;

FIG. 4 is a plot of water contact angle as a function of the number of damage cycles for a glass-ceramic substrate and a comparative glass after washing with a pH 12 detergent;

FIG. 5 is scanning electron microscopy (SEM) images of a top-down and cross-section view of glass-ceramic articles according to an embodiment after undergoing a liquid phase deposition process for 15 minutes, 30 minutes, and 45 minutes;

FIG. 6 is a plot of silica oxide layer thickness and RMS surface roughness for glass-ceramic articles according to an embodiment as a function of liquid phase deposition time;

FIG. 7 is a plot of RMS surface roughness for a glass-ceramic substrate, a glass-ceramic article according to an embodiment, the glass-ceramic article after washing one time, and the glass-ceramic article after washing three times;

FIG. 8 is a plot of water contact angle as a function of the number of damage cycles for a glass-ceramic substrate, a glass-ceramic article according to an embodiment, and a comparative glass;

FIG. 9 is a plot of transmittance as a function of wavelength for a glass-ceramic substrate (GC), the glass-ceramic substrate after washing one time (GC 1×), the glass-ceramic substrate after washing three times (GC 3×), a glass-ceramic article according to an embodiment (GCA), the glass-ceramic article after washing one time (GCA 1×), and the glass-ceramic article after washing three times (GCA 3×);

FIG. 10 is a plot of transmittance haze for the samples of FIG. 9;

FIG. 11 is a Weibull plot of Ring-on-Ring test results for a glass-ceramic substrate (GC) and a glass-ceramic article (GCA) according to an embodiment;

FIG. 12 is an image of a conical ramp scratch test and the associated coefficient of friction (COF) plot for a glass-ceramic substrate and a glass-ceramic article according to an embodiment;

FIG. 13 is an interval plot of the result of a Knoop Scratch Test (KST) for a glass-ceramic substrate (GC), a glass-ceramic article according to an embodiment (GCA), and a glass-ceramic article treated with hydrofluoric acid prior to the deposition of the silica layer (GCA HF); and

FIG. 14 is a plot of transmittance as a function of wavelength for a glass-ceramic substrate, a glass-ceramic article according to and embodiment, and the glass-ceramic article after aging.

### DETAILED DESCRIPTION

Reference will now be made in detail to glass-ceramic articles with a surface passivation layer according to various embodiments.

As utilized herein, the term “glass-ceramic” refers to materials that include an amorphous (glassy) phase and at least one crystalline phase. Glass-ceramics, and in particular ion exchangeable glass-ceramics, provide a desirable combination of properties including high strengths, high damage resistance, low frangibility, high transmission across broad microwave frequencies, and visible spectrum transparency or opacity as desired. This combination of properties makes glass-ceramic materials particularly suitable for consumer electronic device display covers and/or housings. Particularly advantageous glass-ceramic materials include lithium aluminosilicate glass-ceramics, such as those that include a lithium disilicate crystal phase. Exemplary glass-ceramic materials are described in U.S. Pat. No. 9,809,488 and U.S. Patent App. Pub. No. 2018/0186686A, each of which are incorporated herein in their entirety.

Due to the presence of inhomogeneous phases (a crystalline phase and a glassy phase) in the glass-ceramic material, and in particular at the surface of the glass-ceramic material, cleaning and polishing processes may result in undesirable pitting of the surface. The pitting is the result of the different properties of the phases present at the surface of the glass-ceramic. For example, the different phases and crystal facets present at the surface of the glass-ceramic may have different reactivities and/or dissolution rates, leading to preferential etching during wet cleaning and/or chemical mechanical polishing processes. In addition, due to the different hardnesses of the phases present at the surface of the glass-ceramic mechanical polishing processes may remove the phases at different rates. The differential effect of these processes may generate pitting at the glass-ceramic surface which degrades the performance of coatings applied to the surface, such as easy-to-clean (ETC) coatings. An exemplary ETC coating may be a perfluoropolyether (PFPE). Pits with diameters in the range of 10 nm to 30 nm, such as those produced by cleaning or polishing processes, may degrade ETC performance.

The glass-ceramic articles described herein include a surface passivation layer disposed over the surface of a glass-ceramic substrate. The surface passivation layer may be produced by a liquid phase deposition (LPD) process. The surface passivation layer serves to passivate the inhomogenous glass-ceramic surface, which enhances the performance of subsequently deposited ETC layers. The surface passivation layer produces an article surface with improved smoothness and increases resistance to pitting induced by differential etching during washing and polishing processes. The surface passivation layer produces these beneficial effects without degrading the optical, mechanical, and chemical durability properties of the glass-ceramic material.

Existing wash processes for the processing of glass-ceramic materials employ a detergent with a pH of greater than or equal to 10 to remove residue, such as from polishing slurries. The high pH detergent results in preferential etching of the surface of the glass-ceramic and producing surface pitting. A strong correlation has been observed between surface pitting and the performance of ETC coatings applied to the glass-ceramic. Generally, the higher the density of surface pitting and the deeper the pits the more significantly the ETC performance is degraded. Passivation of the glass-ceramic surface to fill pitting and smooth the surface with a homogenous oxide layer, such as a silica layer, of the type described herein have demonstrated significantly improved ETC coating performance without compromising optical and mechanical performance of the glass-ceramic article. For example, the surface passivation layers described herein improve ETC coating performance by increasing the durability of such coatings.

The passivation surface layer described herein is an oxide layer. The oxide layer may include any appropriate oxide. In embodiments, the oxide layer includes SiO₂, Al₂O₃, TiO₂, or combinations thereof. The oxide layer may be homogeneous. In embodiments, the oxide layer may be a homogeneous SiO₂ layer. The oxide layer may be disposed directly on the surface of the glass-ceramic substrate.

The oxide layer may have a surface that is smoother than the surface of the glass-ceramic substrate on which it is disposed. The smoothness of the surface may be characterized based on the root mean square (RMS) surface roughness, as measured by atomic force microscopy (AFM). If the RMS surface is too high, the performance of any ETC coatings disposed thereon may be degraded. In embodiments, the oxide layer has a RMS surface roughness of less than or equal to 3 nm, such as greater than or equal to 0 nm to less than or equal to 3.0 nm, greater than or equal to 0.25 nm to less than or equal to 2.75 nm, greater than or equal to 0.5 nm to less than or equal to 2.5 nm, greater than or equal to 0.75 nm to less than or equal to 2.25 nm, greater than or equal to 1.0 nm to less than or equal to 2.0 nm, greater than or equal to 1.25 nm to less than or equal to 1.75 nm, greater than or equal to 1.0 nm to less than or equal to 1.5 nm, and any and all sub-ranges formed between any of the foregoing endpoints.

The oxide layer may have any appropriate thickness. If the oxide layer is not sufficiently thick, pitting in the surface of the glass-ceramic substrate may not be adequately filled and the desired RMS surface roughness may not be achieved. An oxide layer that is too thick may result in undesirable changes to the physical and/or optical properties of the glass-ceramic article. In embodiments, the oxide layer has a thickness of greater than or equal to 20 nm to less than or equal to 200 nm, such as greater than or equal to 25 nm to less than or equal to 195 nm, greater than or equal to 30 nm to less than or equal to 190 nm, greater than or equal to 35 nm to less than or equal to 185 nm, greater than or equal to 40 nm to less than or equal to 180 nm, greater than or equal to 45 nm to less than or equal to 175 nm, greater than or equal to 50 nm to less than or equal to 170 nm, greater than or equal to 55 nm to less than or equal to 165 nm, greater than or equal to 60 nm to less than or equal to 160 nm, greater than or equal to 65 nm to less than or equal to 155 nm, greater than or equal to 70 nm to less than or equal to 150 nm, greater than or equal to 75 nm to less than or equal to 145 nm, greater than or equal to 80 nm to less than or equal to 140 nm, greater than or equal to 85 nm to less than or equal to 135 nm, greater than or equal to 90 nm to less than or equal to 130 nm, greater than or equal to 95 nm to less than or equal to 125 nm, greater than or equal to 100 nm to less than or equal to 120 nm, greater than or equal to 105 nm to less than or equal to 115 nm, greater than or equal to 100 nm to less than or equal to 110 nm, and any and all sub-ranges formed between any of the foregoing endpoints.

The glass-ceramic substrates of the glass-ceramic articles described herein include an amorphous phase and at least one crystalline phase. The amorphous phase may be an aluminosilicate glass, such as an alkali aluminosilicate glass. In embodiments, the amorphous phase is a lithium aluminosilicate. The crystalline phase may include at least one of petalite, lithium disilicate, lithium silicate, lithium phosphate, beta-spodumene, beta-quartz, spinel, mullite, fluormica, lithium metasilicate, forsterite, nepheline, or Li—Zn—Mg orthosilicate. In embodiments, the glass-ceramic substrate includes petalite and lithium disilicate as crystalline phases. In embodiments, the glass-ceramic substrate includes petalite and lithium disilicate as crystalline phases and lithium aluminosilicate as an amorphous phase.

The glass-ceramic substrates utilized to form the glass-ceramic articles may be chemically strengthened, such as by ion exchange. The chemically strengthened glass-based substrates include a compressive stress layer that extends from the surface of the glass-based substrate into the glass-based substrate to a depth of compression, as described in more detail below. In embodiments, the glass-based substrates are ion exchanged to form a compressive stress layer prior to the deposition of the oxide layer.

The glass-ceramic articles may additionally include an additional layer disposed over the oxide layer. The additional layer may be any layer that is typically applied to the surface of glass or glass-ceramic materials utilized in consumer electronic devices, such as an easy-to-clean (ETC) coating, an antiglare coating, and/or an antireflection coating. In embodiments, the glass-ceramic article includes an ETC coating disposed over the oxide layer. The ETC coating may be any coating providing the desired performance, such as a perfluoropolyether (PFPE) coating. The ETC coating may be formed by any appropriate process.

The glass-ceramic articles described herein may be characterized in terms of the properties they possess. In particular, the optical properties of the glass-ceramic articles may be characterized. For example, the transmittance haze and transmittance in the visible spectrum of the glass-ceramic articles may be characterized. If the transmittance haze is too high and/or the transmittance in the visible spectrum is too low, the glass-ceramic articles may not be suitable for use as cover plates in consumer electronic devices.

The glass-ceramic articles may have a transmittance haze that is low enough to provide the desired optical clarity when employed as a cover plate over a display, such as in a consumer electronic device. The transmittance haze is measured with a commercially available haze meter. In embodiments, the glass-ceramic articles may have a transmittance haze of less than or equal to 1%, such as less than or equal to 0.95%, less than or equal to 0.90%, less than or equal to 0.85%, less than or equal to 0.80%, less than or equal to 0.75%, less than or equal to 0.70%, less than or equal to 0.65%, less than or equal to 0.60%, less than or equal to 0.55%, less than or equal to 0.50%, less than or equal to 0.45%, less than or equal to 0.40%, less than or equal to 0.35%, less than or equal to 0.30%, less than or equal to 0.25%, less than or equal to 0.20%, less than or equal to 0.15%, less than or equal to 0.10%, and any and all sub-ranges formed between any of the foregoing endpoints. In embodiments, the glass-ceramic articles have a transmittance haze of less than or equal to 0.15%. Where the glass-ceramic substrate is opaque, such as for use in the housing of an electronic device, the transmittance haze may not be a relevant characteristic.

The glass-ceramic articles may have a transmittance in the visible spectrum that is high enough to provide the desired optical clarity when employed as a cover plate over a display, such as in a consumer electronic device. The transmittance is measured by a commercially available UV-VIS spectrophotometer. Reduced transmittance in the visible spectrum may also increase the power use of a display in which the glass-ceramic article is employed as a cover plate, as the display may require increased brightness to achieve the desired appearance. In embodiments, the glass-ceramic articles may have a transmittance over the entirety of the wavelength range from 400 nm to 700 nm of greater than or equal to 90%, such as greater than or equal to 91%, greater than or equal to 92%, greater than or equal to 93%, greater than or equal to 94%, greater than or equal to 95%, greater than or equal to 96%, greater than or equal to 97%, greater than or equal to 98%, greater than or equal to 99%, or more.

The glass-ceramic substrates utilized to form the glass-ceramic articles may be formed by any appropriate process. In embodiments, the glass-ceramic substrates may be formed by ceramming a precursor glass to form crystalline phases in the amorphous glass and produce the glass-ceramic substrate. The glass-ceramic substrates may be mechanically and/or chemically processed to produce the desired geometry prior to the deposition of the oxide layer and/or chemical strengthening.

The oxide layer is formed by a liquid phase deposition (LPD) process. The LPD process includes contacting a liquid solution with the surface of the glass-ceramic substrate to deposit the oxide layer on the glass-ceramic article. The solution is selected such that the desired oxide layer is produced. In embodiments, the LPD process may be performed as a batch process.

The contacting of the liquid solution with the surface of the glass-ceramic substrate extends for any appropriate time period. The contacting may extend for a time period of greater than or equal to 2 minutes to less than or equal to 1 hour, such as greater than or equal to 10 minutes to less than or equal to 60 minutes, greater than or equal to 15 minutes to less than or equal to 45 minutes, greater than or equal to 20 minutes to less than or equal to 55 minutes, greater than or equal to 25 minutes to less than or equal to 50 minutes, greater than or equal to 30 minutes to less than or equal to 45 minutes, greater than or equal to 35 minutes to less than or equal to 40 minutes, and any and all sub-ranges formed between any of the foregoing endpoints. In the case where the contacting is too short, the oxide layer may be too thin and not produce the desired result. If the contacting extends for too long the efficiency of the process is reduced and the optical and/or mechanical properties of the glass-ceramic article may be negatively impacted.

The liquid solution may beat any appropriate temperature during the contacting with the glass-ceramic substrate. The liquid solution may be utilized at any temperature between the freezing point and the boiling point thereof. If the temperature of the liquid solution is too low the deposition may be prohibitively slow, and if the temperature of the liquid solution is too high the quality of the deposited oxide layer may be undesirably reduced. In embodiments, the liquid solution may be at a temperature in the range of greater than or equal to 25° C. to less than or equal to 60° C., such as greater than or equal to 30° C. to less than or equal to 55° C., greater than or equal to 35° C. to less than or equal to 50° C., greater than or equal to 40° C. to less than or equal to 45° C., and any and all sub-ranges formed between any of the foregoing endpoints. In embodiments, the liquid solution may be at a temperature of 40° C. or 50° C.

By way of example, a homogeneous silica oxide layer may be formed using a liquid solution containing H₂SiF₆ and B(OH)₃. The LPD process for such a liquid solution is controlled by the following reactions:

H₂SiF₆+H₂O↔6HF+SiO₂

B(OH)₃+4HF↔BF₄⁻+H₃O⁻+2H₂O

By controlling H₂SiF₆ and B(OH)₃ concentration the deposited silica density and growth rate may be controlled. Higher H₂SiF₆ concentrations produce denser SiO₂ layers, and higher B(OH)₃ concentrations result in higher silica growth rates higher silica layer porosity.

Any appropriate liquid solution may be utilized to form the oxide layer. To deposit a silica layer a liquid solution containing H₂SiF₆ and B(OH)₃ may be employed. The H₂SiF₆ concentration in the liquid solution may be in the range from greater than or equal to 0.1 M to less than or equal to 3 M, such as greater than or equal to 0.25 M to less than or equal to 3 M, greater than or equal to 0.5 M to less than or equal to 3 M, greater than or equal to 0.75 M to less than or equal to 2.75 M, greater than or equal to 1 M to less than or equal to 2.5 M, greater than or equal to 1.25 M to less than or equal to 2.25 M, greater than or equal to 1.5 M to less than or equal to 2 M, greater than or equal to 1.5 M to less than or equal to 1.75 M, and any and all sub-ranges formed between any of the foregoing endpoints. The B(OH)₃ concentration in the liquid solution may be in the range from greater than or equal to 0.05 M to less than or equal to 2.0 M, such as greater than or equal to 0.05 M to less than or equal to 0.5 M, greater than or equal to 0.1 M to less than or equal to 0.45 M, greater than or equal to 0.15 M to less than or equal to 0.4 M, greater than or equal to 0.2 M to less than or equal to 0.35 M, greater than or equal to 0.25 M to less than or equal to 0.3 M, greater than or equal to 0.5 M to less than or equal to 1.75 M, greater than or equal to 0.75 M to less than or equal to 1.5 M, greater than or equal to 1.0 M to less than or equal to 1.25 M, and any and all sub-ranges formed between any of the foregoing endpoints. In embodiments, B(OH)₃ may be wholly or partially replaced in the liquid solution by Ca(OH)₂. In embodiments, the Ca(OH)₂ concentration in the liquid solution may be in the range from greater than or equal to 0.01 M to less than or equal to 2.0 M, such as greater than or equal to 0.05 M to less than or equal to 0.4 M, greater than or equal to 0.1 M to less than or equal to 0.35 M, greater than or equal to 0.15 M to less than or equal to 0.3 M, greater than or equal to 0.2 M to less than or equal to 0.25 M, greater than or equal to 0.5 M to less than or equal to 1.75 M, greater than or equal to 0.75 M to less than or equal to 1.5 M, greater than or equal to 1.0 M to less than or equal to 1.5 M, and any and all sub-ranges formed between any of the foregoing endpoints.

The liquid solution may be selected to deposit an oxide layer containing TiO₂, such as a homogeneous TiO₂ layer, on the glass-ceramic substrate. In such embodiments, the liquid solution may contain (NH₄)₂TiF₆ and B(OH)₃.

The liquid solution may be selected to deposit an oxide layer containing Al₂O₃, such as a homogeneous Al₂O₃ layer, on the glass-ceramic substrate. In such embodiments, the liquid solution may contain Al₂(SO₄)₃ and NaHCO₃.

The liquid solution may be selected to deposit an oxide layer that contains a mixture of oxides. In embodiments, the liquid solution may include a mixture of any of the components described herein.

It should be understood that any of the variously recited ranges of one component may be individually combined with any of the variously recited ranges for any other component. As used herein, a trailing 0 in a number is intended to represent a significant digit for that number. For example, the number “1.0” includes two significant digits, and the number “1.00” includes three significant digits.

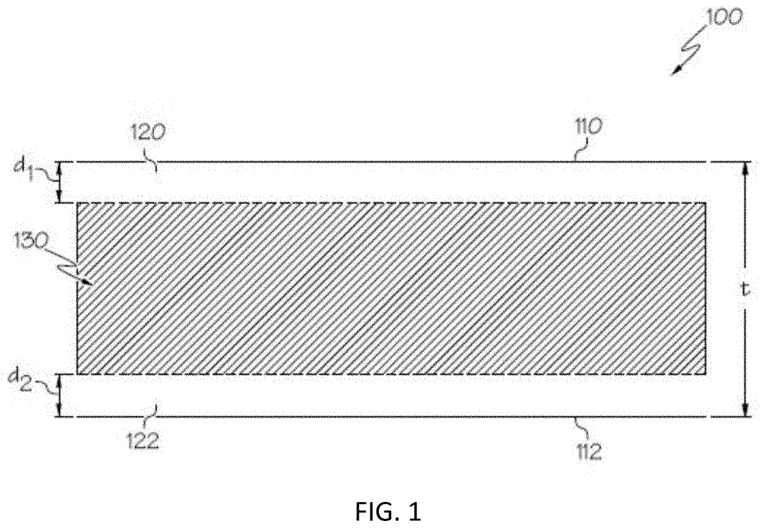

As mentioned above, in embodiments, the glass-ceramic substrates described herein can be strengthened, such as by ion exchange, making a glass-ceramic substrate that is damage resistant for applications such as, but not limited to, display covers. With reference to FIG. 1, a glass-ceramic substrate is depicted that has a first region under compressive stress (e.g., first and second compressive layers 120, 122 in FIG. 1) extending from the surface to a depth of compression (DOC) of the glass-ceramic substrate and a second region (e.g., central region 130 in FIG. 1) under a tensile stress or central tension (CT) extending from the DOC into the central or interior region of the glass-ceramic substrate. As used herein, DOC refers to the depth at which the stress within the glass-ceramic substrate changes from compressive to tensile. At the DOC, the stress crosses from a positive (compressive) stress to a negative (tensile) stress and thus exhibits a stress value of zero.

According to the convention normally used in the art, compression or compressive stress is expressed as a negative (<0) stress and tension or tensile stress is expressed as a positive (>0) stress. Throughout this description, however, CS is expressed as a positive or absolute value—i.e., as recited herein, CS=|CS|. The compressive stress (CS) has a maximum at or near the surface of the glass article, and the CS varies with distance d from the surface according to a function. Referring again to FIG. 1, a first segment 120 extends from first surface 110 to a depth d₁ and a second segment 122 extends from second surface 112 to a depth d₂. Together, these segments define a compression or CS of glass-ceramic substrate 100. Compressive stress (including surface CS) may be measured by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured according to Procedure C (Glass Disc Method) described in ASTM standard C770-16, entitled “Standard Test Method for Measurement of Glass Stress-Optical Coefficient,” the contents of which are incorporated herein by reference in their entirety.

In embodiments, the CS of the glass-ceramic substrates is from greater than or equal to 100 MPa to less than or equal to 1000 MPa, such as from greater than or equal to 150 MPa to less than or equal to 950 MPa, from greater than or equal to 200 MPa to less than or equal to 900 MPa, from greater than or equal to 250 MPa to less than or equal to 850 MPa, from greater than or equal to 300 MPa to less than or equal to 800 MPa, from greater than or equal to 350 MPa to less than or equal to 750 MPa, from greater than or equal to 400 MPa to less than or equal to 700 MPa, from greater than or equal to 450 MPa to less than or equal to 650 MPa, from greater than or equal to 500 MPa to less than or equal to 600 MPa, from greater than or equal to 500 MPa to less than or equal to 550 MPa, and any and all sub-ranges between the foregoing endpoints.

The compressive stress of both major surfaces 110, 112 in FIG. 1 is balanced by stored tension in the central region 130 of the glass-ceramic substrate. The maximum central tension (CT) and DOC values may be measured using a scattered light polariscope (SCALP) technique known in the art. The refracted near-field (RNF) method or SCALP may be used to determine the stress profile of the glass-ceramic substrates. When the RNF method is utilized to measure the stress profile, the maximum CT value provided by SCALP is utilized in the RNF method. In particular, the stress profile determined by RNF is force balanced and calibrated to the maximum CT value provided by a SCALP measurement. The RNF method is described in U.S. Pat. No. 8,854,623, entitled “Systems and methods for measuring a profile characteristic of a glass sample”, which is incorporated herein by reference in its entirety. In particular, the RNF method includes placing the glass-ceramic substrate adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass-ceramic substrate sample from the normalized detector signal.

In embodiments, the glass-ceramic substrates may have a maximum CT greater than or equal to 20 MPa, such as greater than or equal to 25 MPa, greater than or equal to 30 MPa, greater than or equal to 35 MPa, greater than or equal to 40 MPa, greater than or equal to 45 MPa, greater than or equal to 50 MPa, greater than or equal to 55 MPa, greater than or equal to 60 MPa, greater than or equal to 65 MPa, greater than or equal to 70 MPa, greater than or equal to 75 MPa, greater than or equal to 80 MPa, greater than or equal to 85 MPa, greater than or equal to 90 MPa, greater than or equal to 95 MPa, greater than or equal to 100 MPa, or greater than or equal to 105 MPa, and all ranges and sub-ranges between the foregoing values. In some embodiments, the glass-ceramic substrate may have a maximum CT less than or equal to 110 MPa, such as less than or equal to 105 MPa, less than or equal to 100 MPa, less than or equal to 95 MPa, less than or equal to 90 MPa, less than or equal to 85 MPa, less than or equal to 80 MPa, less than or equal to 75 MPa, less than or equal to 70 MPa, less than or equal to 65 MPa, less than or equal to 60 MPa, less than or equal to 55 MPa, less than or equal to 50 MPa, less than or equal to 45 MPa, less than or equal to 40 MPa, less than or equal to 35 MPa, less than or equal to 30 MPa, or less than or equal to 25 MPa, and all ranges and sub-ranges between the foregoing values. It should be understood that, in embodiments, any of the above ranges may be combined with any other range, such that the glass-ceramic substrate may have a maximum CT from greater than or equal to 20 MPa to less than or equal to 110 MPa, such as from greater than or equal to 25 MPa to less than or equal to 105 MPa, from greater than or equal to 30 MPa to less than or equal to 100 MPa, from greater than or equal to 35 MPa to less than or equal to 95 MPa, from greater than or equal to 40 MPa to less than or equal to 90 MPa, from greater than or equal to 45 MPa to less than or equal to 85 MPa, from greater than or equal to 50 MPa to less than or equal to 80 MPa, from greater than or equal to 55 MPa to less than or equal to 75 MPa, from greater than or equal to 60 MPa to less than or equal to 70 MPa, and all ranges and sub-ranges between the foregoing values.

As noted above, DOC is measured using a scattered light polariscope (SCALP) technique known in the art. The DOC is provided in some embodiments herein as a portion of the thickness (t) of the glass article. In embodiments, the glass-ceramic substrates may have a depth of compression (DOC) from greater than or equal to 0.15t to less than or equal to 0.25t, such as from greater than or equal to 0.18t to less than or equal to 0.22t, or from greater than or equal to 0.19t to less than or equal to 0.21t, and all ranges and sub-ranges between the foregoing values.

Compressive stress layers may be formed in the glass-ceramic substrate by exposing the glass-ceramic substrate to an ion exchange solution. In embodiments, the ion exchange solution may be molten nitrate salt. In some embodiments, the ion exchange solution may be molten KNO₃, molten NaNO₃, or combinations thereof. In certain embodiments, the ion exchange solution may comprise less than about 100% molten KNO₃, such as less than about 95% molten KNO₃, less than about 90% molten KNO₃, less than about 80% molten KNO₃, less than about 70% molten KNO₃, less than about 60% molten KNO₃, or less than about 50% molten KNO₃. In certain embodiments, the ion exchange solution may comprise at least about 5% molten NaNO₃, such as at least about 10% molten NaNO₃, at least about 20% molten NaNO₃, at least about 30% molten NaNO₃, or at least about 40% molten NaNO₃. In other embodiments, the ion exchange solution may comprise about 95% molten KNO₃ and about 5% molten NaNO₃, about 94% molten KNO₃ and about 6% molten NaNO₃, about 93% molten KNO₃ and about 7% molten NaNO₃, about 90% molten KNO₃ and about 10% molten NaNO₃, about 80% molten KNO₃ and about 20% molten NaNO₃, about 75% molten KNO₃ and about 25% molten NaNO₃, about 70% molten KNO₃ and about 30% molten NaNO₃, about 65% molten KNO₃ and about 35% molten NaNO₃, or about 60% molten KNO₃ and about 40% molten NaNO₃, and all ranges and sub-ranges between the foregoing values. In embodiments, other sodium and potassium salts may be used in the ion exchange solution, such as, for example sodium or potassium nitrites, phosphates, or sulfates. In embodiments, the ion exchange solution may include lithium salts, such as LiNO₃.

The glass-ceramic substrate may be exposed to the ion exchange solution by dipping a glass-ceramic substrate into a bath of the ion exchange solution, spraying the ion exchange solution onto a glass-ceramic substrate, or otherwise physically applying the ion exchange solution to a glass-ceramic substrate to form the ion exchanged glass-ceramic substrate. Upon exposure to the glass-ceramic substrate, the ion exchange solution may, according to embodiments, be at a temperature from greater than or equal to 360° C. to less than or equal to 500° C., such as from greater than or equal to 370° C. to less than or equal to 490° C., from greater than or equal to 380° C. to less than or equal to 480° C., from greater than or equal to 390° C. to less than or equal to 470° C., from greater than or equal to 400° C. to less than or equal to 460° C., from greater than or equal to 410° C. to less than or equal to 450° C., from greater than or equal to 420° C. to less than or equal to 440° C., greater than or equal to 430° C., and all ranges and sub-ranges between the foregoing values. In embodiments, the glass-ceramic substrate may be exposed to the ion exchange solution for a duration from greater than or equal to 4 hours to less than or equal to 48 hours, such as from greater than or equal to 8 hours to less than or equal to 44 hours, from greater than or equal to 12 hours to less than or equal to 40 hours, from greater than or equal to 16 hours to less than or equal to 36 hours, from greater than or equal to 20 hours to less than or equal to 32 hours, or from greater than or equal to 24 hours to less than or equal to 28 hours, and all ranges and sub-ranges between the foregoing values.

After an ion exchange process is performed, it should be understood that a composition at the surface of an ion exchanged glass-ceramic substrate is different than the composition of the as-formed glass-ceramic substrate (i.e., the glass-ceramic substrate before it undergoes an ion exchange process). This results from one type of alkali metal ion in the as-formed glass substrate, such as, for example Li⁺ or Na⁺, being replaced with larger alkali metal ions, such as, for example Na⁺ or K⁺, respectively. However, the composition at or near the center of the depth of the glass-ceramic substrate will, in embodiments, still have the composition of the as-formed non-ion exchanged glass-ceramic substrate utilized to form the ion exchanged glass-ceramic substrate.

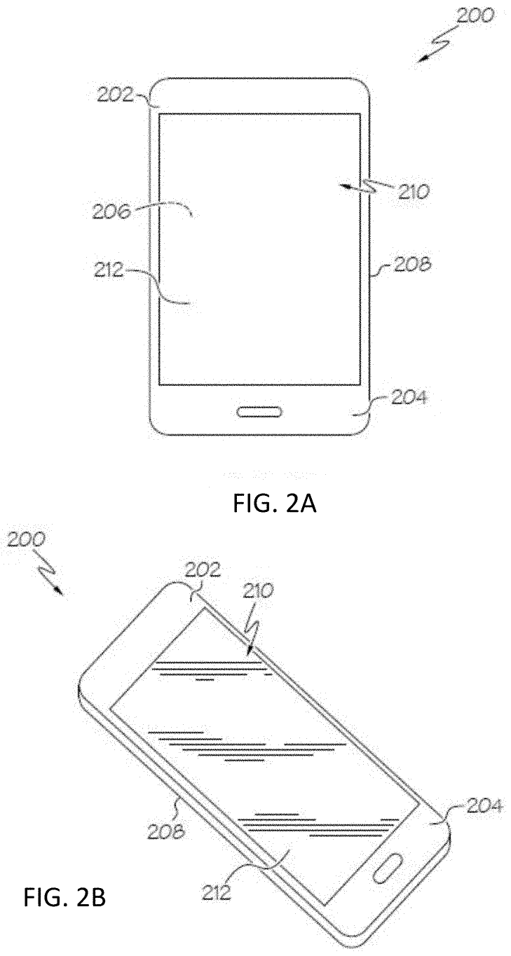

The glass-ceramic articles disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any article that requires some transparency, scratch-resistance, abrasion resistance or a combination thereof. An exemplary article incorporating any of the glass-ceramic articles disclosed herein is shown in FIGS. 2A and 2B. Specifically, FIGS. 2A and 2B show a consumer electronic device 200 including a housing 202 having front 204, back 206, and side surfaces 208; electrical components (not shown) that are at least partially inside or entirely within the housing and including at least a controller, a memory, and a display 210 at or adjacent to the front surface of the housing; and a cover plate 212 at or over the front surface of the housing such that it is over the display. In embodiments, at least a portion of at least one of the cover plate 212 or the housing 202 may include any of the glass-ceramic articles described herein.

### Examples

Embodiments will be further clarified by the following examples. It should be understood that these examples are not limiting to the embodiments described above.

An exemplary glass-ceramic substrate including a lithium aluminosilicate amorphous phase, a petalite crystalline phase, and a lithium disilicate crystalline phase was formed.

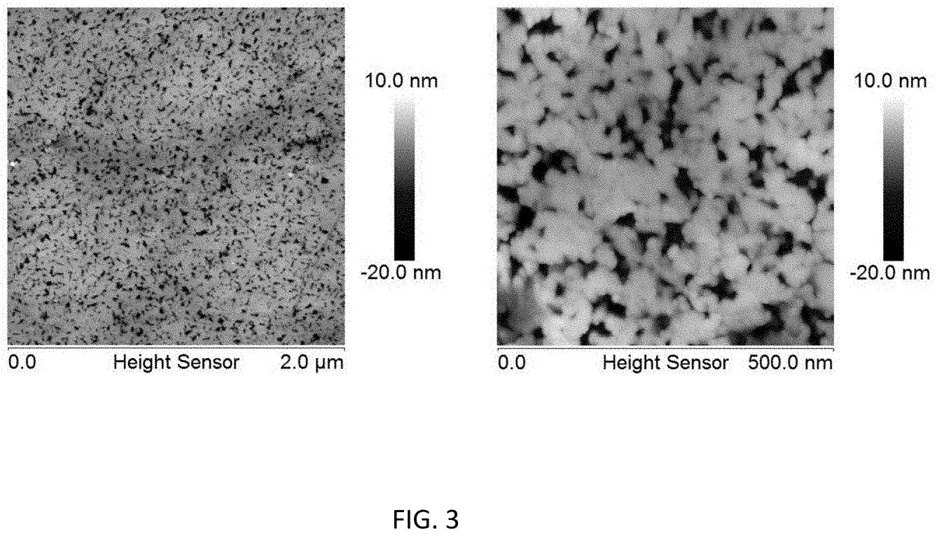

The surface of the glass-ceramic substrates was polished with a cerium oxide slurry and then washed with pH 12 detergent. An atomic force microscopy (AFM) image of the resulting glass-ceramic substrate surface is shown at two different magnifications in FIG. 3. The differential etching produced by the polishing and washing process produced a RSM surface roughness in the range of 3 to 4 nm.

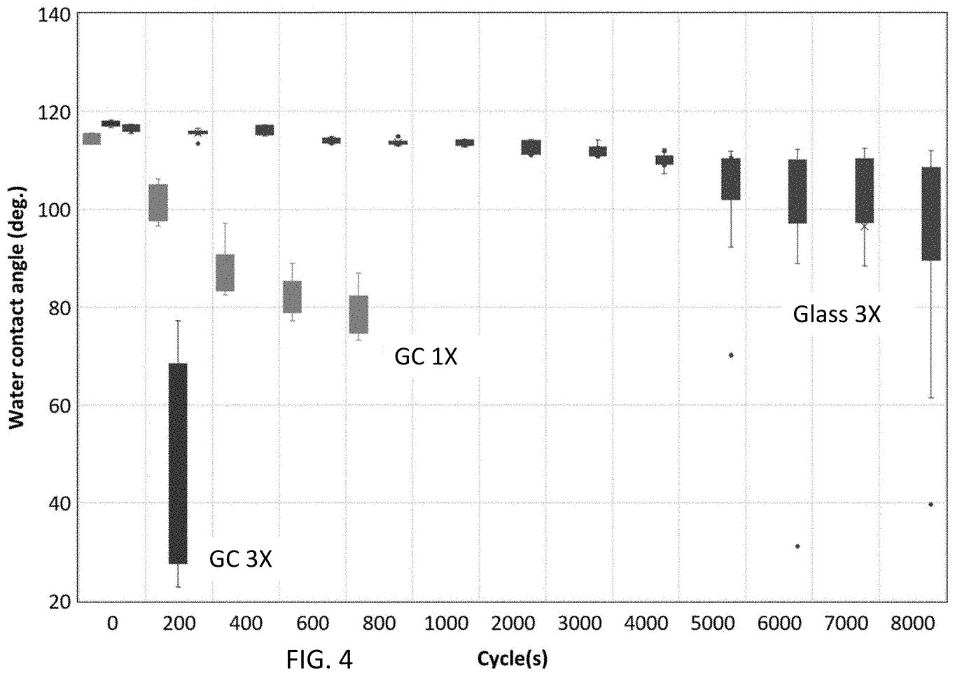

The glass-ceramic substrate was subjected to washing with a detergent with a pH of 12, with a sample washed one time (GC 1×) and a second sample washed three times (GC 3×). A comparative glass sample (Glass 3×) was also washed three times with the detergent. Each of the samples was then abraded with steel wool, and the water contact angle was measured. FIG. 4 shows the measured water contact angle as a function of abrasion cycles for each sample, with a higher water contact angle indicating better ETC performance. As observed in FIG. 4, there is a strong correlation between surface pitting and ETC performance, as the glass-ceramic substrate subjected to three washes (GC 3×) exhibited more pitting than the glass-based substrate washed one time (1×) and the comparative glass sample (Glass 3×) exhibited the least pitting.

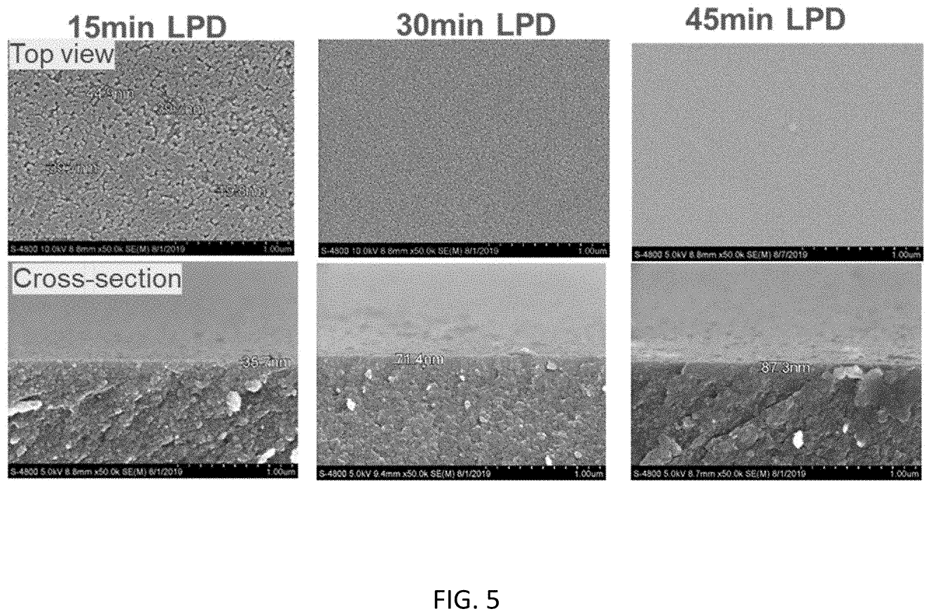

The glass-ceramic substrate was subjected to a LPD process to form a silica layer on the surface thereof. The silica oxide layer was analyzed after contacting times of 15 minutes (15 min LPD), 30 minutes (30 min LPD), and 45 minutes (45 min LPD). FIG. 5 shows both top-down views and cross-sections of the samples after each contacting time, as produced by scanning electron microscopy (SEM). As shown in FIG. 5, after 15 to 30 minutes of the LPD process the silica oxide layer filled the pitting on the glass-ceramic substrate surface. After 30 minutes, a homogeneous layer of silica with a thickness of 70 nm evolved, passivating the surface of the glass-ceramic substrate.

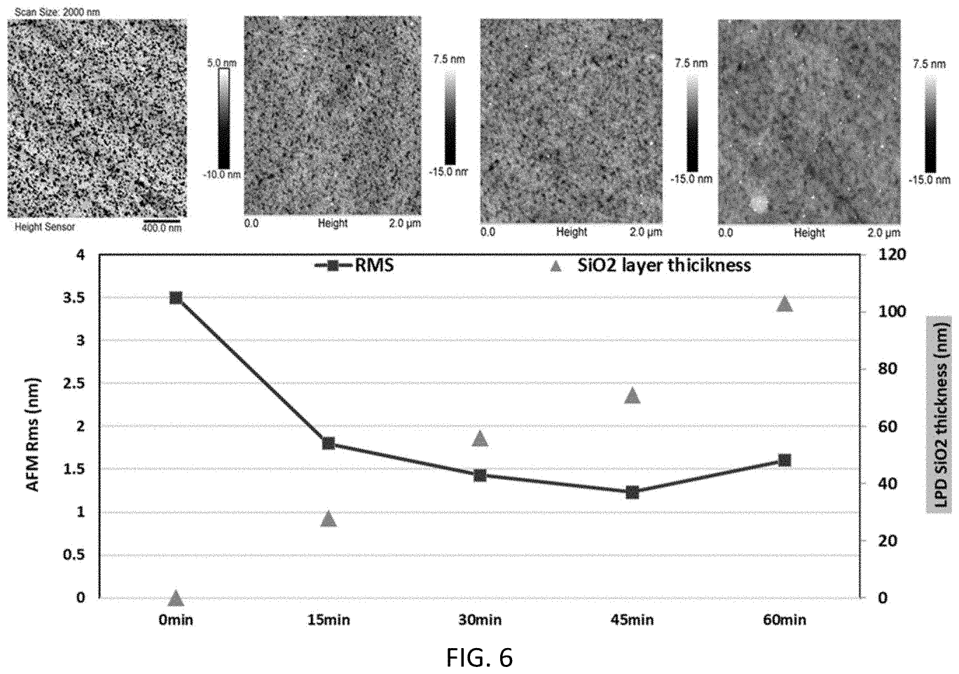

FIG. 6 shows the RMS surface roughness and silica layer thickness as a function of LPD time for a glass-ceramic article of the type described above. As shown in FIG. 6, the liquid phase deposited silica not only filled pitting on the surface of the glass-ceramic substrate but also generated a significantly smoother surface, with RMS surface roughness improving from 3.6 nm for the non-passivated glass-ceramic substrate to 1.6 nm for the glass-ceramic article produced after 45 minutes of LPD. The inset images in FIG. 6 are the AFM images of the surface of the glass-ceramic at the indicated LPD times.

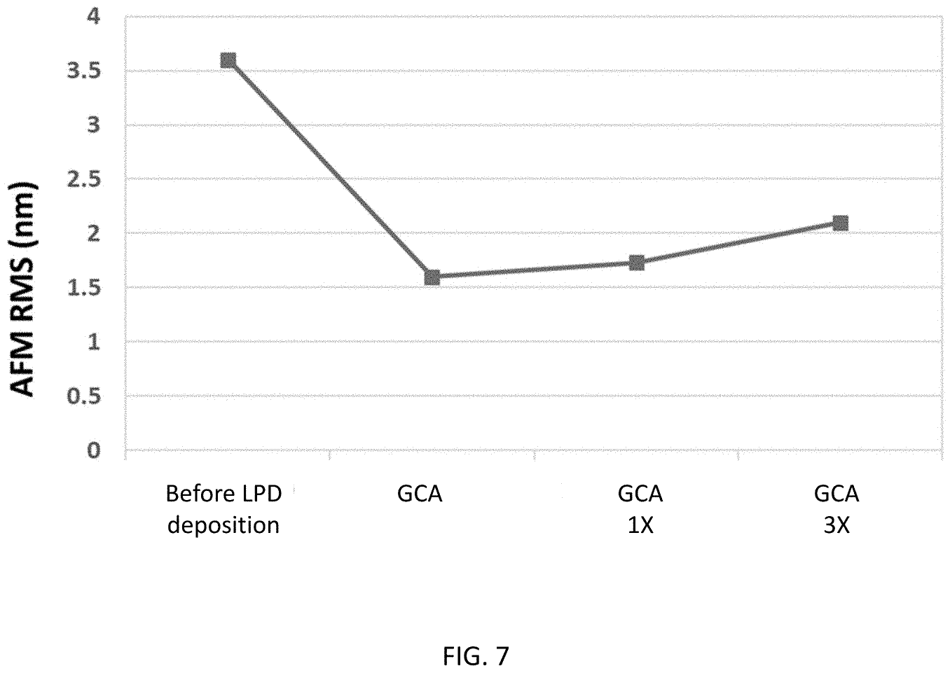

The resistance of the glass-ceramic article with the LPD produced silica layer was also measured. The RMS surface roughness of the glass-ceramic substrate was measured before LPD deposition, on the glass-ceramic article (GCA) with the silica layer after LPD deposition, after washing the glass-ceramic article one time (GCA 1×), and after washing the glass-ceramic article three times (GCA 3×). The washing was conducted with a pH 12 detergent at 70° C. As shown in FIG. 7, after washing the glass-ceramic article one time the RMS surface roughness increased from 1.52 nm to 1.7 nm, and after washing three times the RMS surface roughness increased to 2.08 nm. The glass-ceramic article did not exhibit an increased RMS surface roughness when washed with a neutral pH solution, indicating that pitting did not occur.

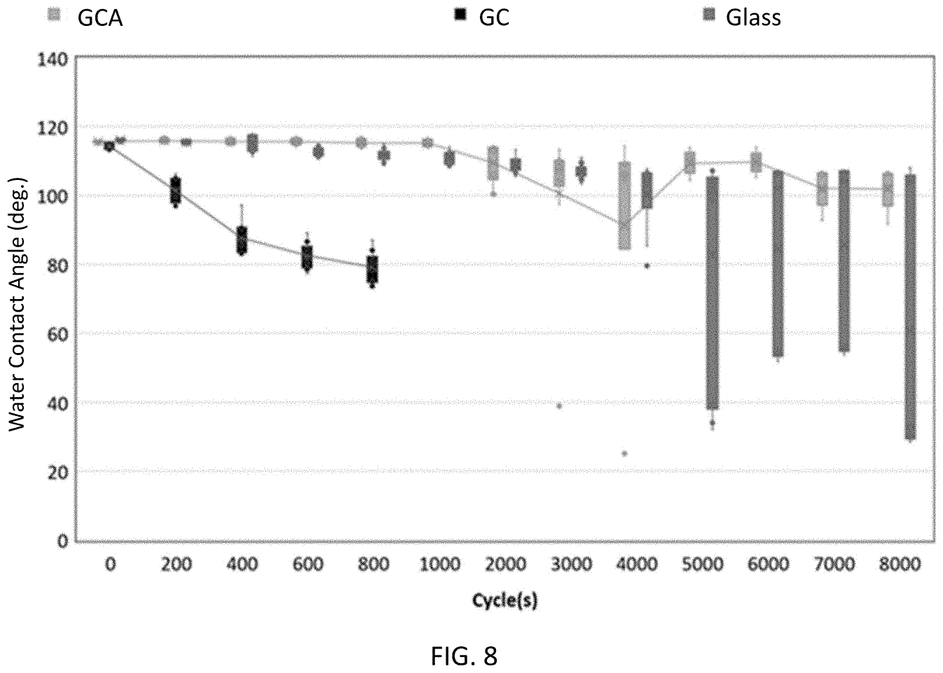

A glass-ceramic substrate (GC) with no LPD produced layer, a glass-ceramic article (GCA) with a silica layer produced after 60 minutes of LPD, and a comparative glass sample (Glass) were abraded with steel wool, and the water contact angle was measured. FIG. 8 shows the measured water contact angle as a function of abrasion cycles for each sample, with a higher water contact angle indicating better ETC performance. As shown in FIG. 8, the resistance to a reduction in ETC performance when subjected to steel wool abrasion was significantly increased for the glass-ceramic article including the LPD produced layer when compared to the non-passivated glass-ceramic substrate.

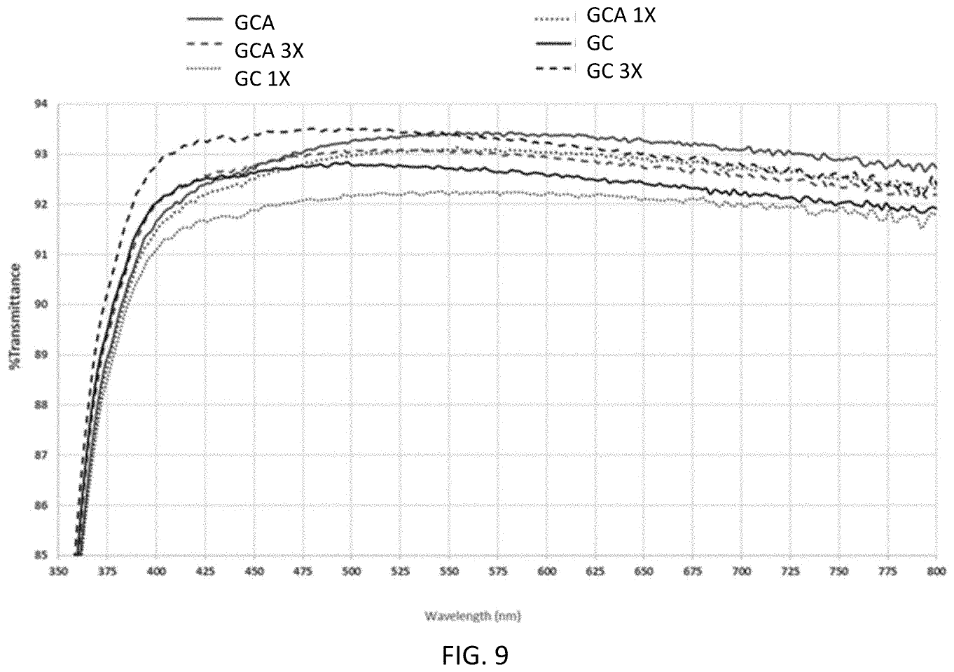

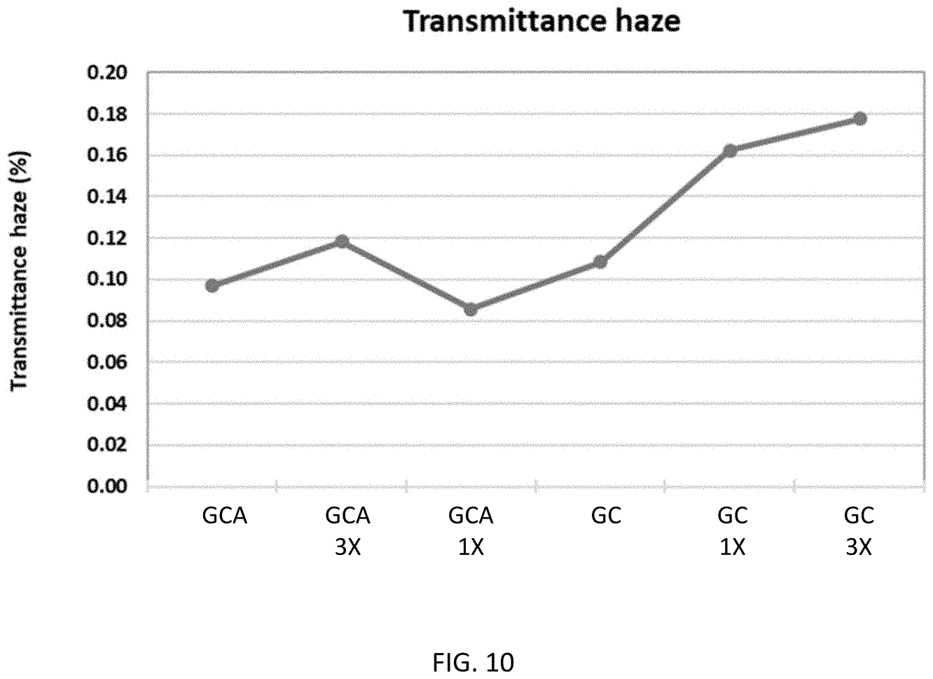

The transmittance was measured for a glass-ceramic substrate (GC), the glass-ceramic substrate after washing one time (GC 1×), the glass-ceramic substrate after washing three times (GC 3×), a glass-ceramic article according to an embodiment (GCA), the glass-ceramic article after washing one time (GCA 1×), and the glass-ceramic article after washing three times (GCA 3×). The washing utilized a pH 12 detergent at 70° C. in an ultrasonic bath, followed by rinsing in deionized water. As shown in FIG. 9, there is no significant degradation of optical transmittance with the addition of the silica passivation layer in the glass-ceramic article when compared to the glass-ceramic substrate, especially after washing. At wavelengths longer than 425 nm, the transmittance for the glass-ceramic article was higher than for the glass-ceramic substrate. Note that the increased transmittance of the glass-ceramic substrate after washing, especially after washing three times is due to preferential etching of the glass-ceramic substrate that induces significant porosity and thus higher transmittance. The transmittance haze was also measured for these samples. As shown in FIG. 10 silica passivated glass-ceramic article exhibited no significant transmittance haze increase after washing.

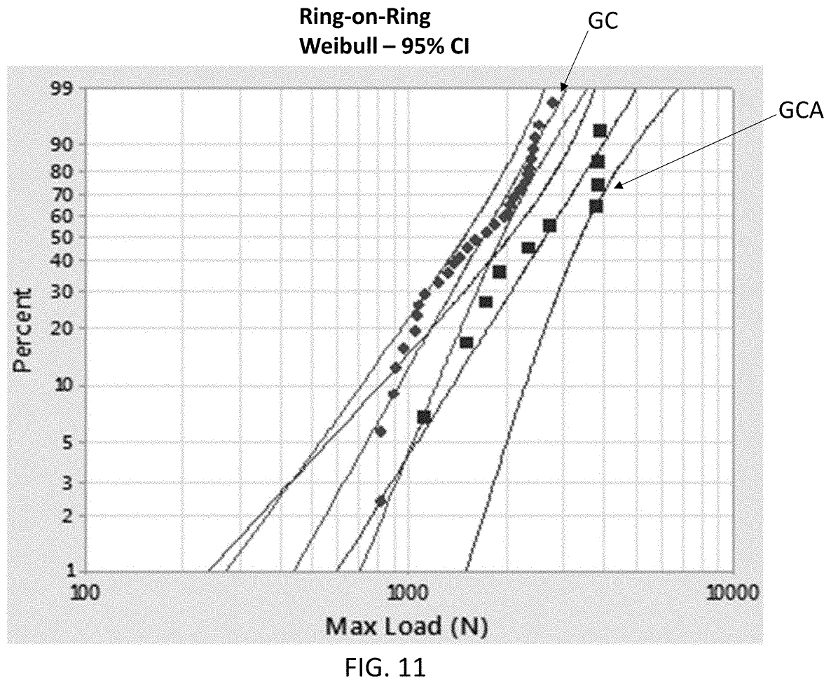

A glass-ceramic substrate and a glass-ceramic article including a 90 nm silica layer were subjected to Ring-on-Ring (ROR) strength testing. As shown in FIG. 11, the glass-ceramic article exhibited an enhanced ROR strength as compared with the glass-ceramic substrate.

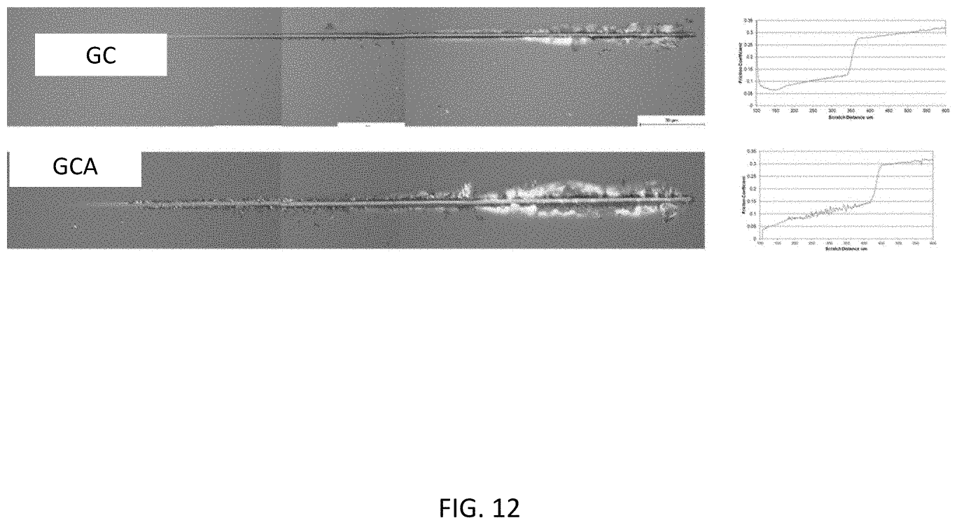

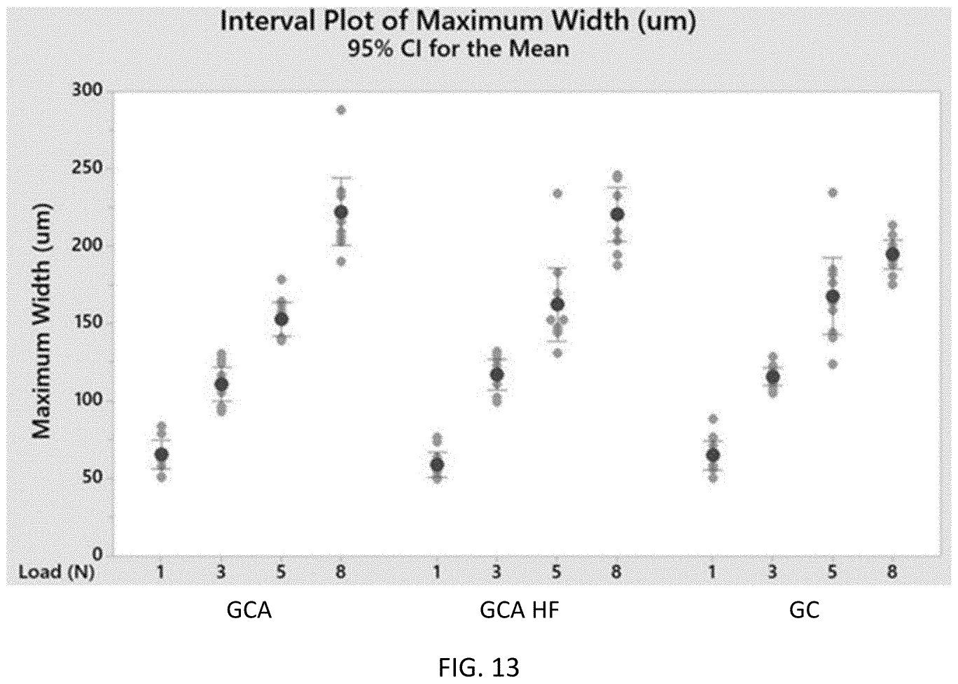

A glass-ceramic substrate (GC) and a glass-ceramic article (GCA) were subjected to a 200 mN conical ramp scratch test, and the resulting scratch and coefficient of friction (COF) plots are shown in FIG. 12. The samples were also subjected to a Knoop Scratch Test (KST), along with a glass-ceramic article sample that was treated with hydrofluoric acid (GCA HF) prior to the deposition of the silica layer, with the results shown in FIG. 13. As demonstrated by the results in FIGS. 12 and 13, the silica layer has no negative impact on surface scratch resistance as there is no significant difference in scratch behavior when the silica layer is present.

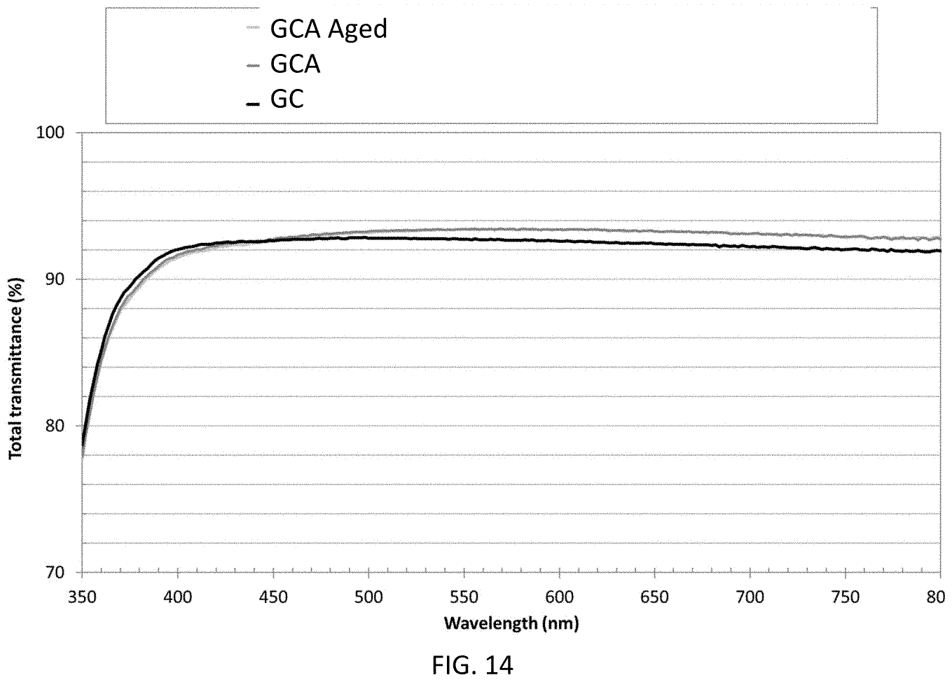

A glass-ceramic article was aged for 12 days in an environment at 85 C and 85% humidity to produce an aged glass-ceramic article (GCA Aged) and determine the durability of the silica layer. Transmittance was measured after the aging, and as shown in FIG. 14 no degradation of the transmittance of the glass-ceramic article was observed after the aging when compared to the non-aged glass-ceramic article. The transmittance of the glass-ceramic substrate without a silica layer is also reported in FIG. 14 for the sake of comparison.

All ranges disclosed in this specification include any and all ranges and subranges encompassed by the broadly disclosed ranges whether or not explicitly stated before or after a range is disclosed.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. An article, comprising:
a glass-ceramic substrate comprising a surface;
an oxide layer disposed over the surface of the glass-ceramic substrate;
wherein the oxide layer has a thickness of greater than or equal to 20 nm to less than or equal to 200 nm and a RMS surface roughness of less than or equal to 3 nm.

2. The article of claim 1, further comprising an easy-to-clean layer disposed over the oxide layer.

3. The article of claim 2, wherein the easy-to-clean layer comprises perfluoropolyether.

4. The article of claim 1, wherein the article exhibits a transmittance haze of less than or equal to 0.15%.

5. The article of claim 1, wherein the article exhibits a transmittance of greater than or equal to 90% over the entirety of the wavelength range from 400 nm to 700 nm.

6. The article of claim 1, wherein the glass-ceramic substrate comprises: petalite, lithium disilicate, lithium silicate, lithium phosphate, beta-spodumene, beta-quartz, spinel, mullite, fluormica, lithium metasilicate, forsterite, nepheline, Li—Zn—Mg orthosilicate, or combinations thereof.

7. The article of claim 1, wherein the glass-ceramic substrate comprises petalite and lithium disilicate.

8. The article of claim 1, wherein the oxide layer comprises SiO₂, Al₂O₃, TiO₂, or combinations thereof.

9. The article of claim 1, wherein the oxide layer comprises SiO₂.

10. The article of claim 1, wherein the glass-based substrate further comprises a compressive stress layer extending from the surface to a depth of compression.

11. A consumer electronic product, comprising:
a housing comprising a front surface, a back surface and side surfaces;
electrical components at least partially within the housing, the electrical components comprising a controller, a memory, and a display, the display at or adjacent the front surface of the housing; and
a cover plate disposed over the display,
wherein at least a portion of at least one of the housing or the cover plate comprises the article of claim 1.

12. A method, comprising:
contacting a liquid solution with a surface of a glass-ceramic substrate to deposit an oxide layer on the surface forming a glass-ceramic article;
wherein the oxide has a thickness of greater than or equal to 20 nm to less than or equal to 200 nm and a RMS surface roughness of less than or equal to 3 nm.

13. The method of claim 12, wherein during the contacting the liquid solution is at a temperature of greater than or equal to 25° C. to less than or equal to 60° C. and the contacting extends for a time period of greater than or equal to 2 minutes to less than or equal to 1 hour.

14. The method of claim 12, wherein the liquid solution comprises H₂SiF₆ and at least one of B(OH)₃ or Ca(OH)₂.

15. The method of claim 12, wherein the liquid solution comprises H₂SiF₆ with a concentration of greater than or equal to 0.1 M to less than or equal to 3 M.

16. The method of claim 12, wherein the liquid solution comprises B(OH)₃ with a concentration of greater than or equal to 0.05 M to less than or equal to 2.0 M.

17. The method of claim 12, wherein the liquid solution comprises Ca(OH)₂ with a concentration of greater than or equal to 0.01 M to less than or equal to 2.0 M.

18. The method of claim 12, wherein the liquid solution comprises Al₂(SO₄)₆ and NaHCO₃.

19. The method of claim 12, wherein the liquid solution comprises (NH₄)₂TiF₆ and B(OH)₃.

20. The method of claim 12, further comprising disposing an easy-to-clean layer over the oxide layer.
